(19) United States
(12) Patent Application Publication
(10) Pub. No.: US 2019/0280494 A1
(43) Pub. Date: Sep. 12, 2019

(54) METHOD AND SYSTEM FOR MANAGING ELECTROCHEMICAL BATTERIES OF A POWER SUPPLY FACILITY IN CASE OF BATTERY FAILURE

(71) Applicant: BLUE SOLUTIONS, Ergue Gaberic (FR)

(72) Inventors: Christian SELLIN, Concarneau (FR); Jean-Jacques JESTIN, Fouesnant (FR); Tony TAN, Rennes (FR); Yvan AGNUS, Quimper (FR); Gilles BRUNET, Ploneis (FR); Michel THOMAS, Pouldreuzic (FR); Dominique HINGANT, Saint Yvi (FR)

(21) Appl. No.: 16/319,453

(22) PCT Filed: Jun. 2, 2017
(86) PCT No.: PCT/EP2017/063545

§ 371 Date: Jan. 21, 2019

(30) Foreign Application Priority Data
Jun. 16, 2016 (FR) 1655626

(51) Int. Cl. H02J 7/00; H02J 3/32; H02J 3/38; H02J 7/35; B60L 53/53

(52) U.S. Cl. CPC H02J 7/0021; H02J 3/32; B60L 53/53; H02J 3/386; H02J 7/35; H02J 3/383

(57) ABSTRACT

A method is provided for managing multiple rechargeable electrical energy storage modules of a power supply facility, arranged in parallel, the method including: separating the modules into at least two groups, and supplying power using the groups one at a time; the method also including a step of replacing a faulty module of a group, referred to as the active group, while being supplied by an available module of another group, referred to as the available group. A system is also provided for implementing such a method and a power supply facility implementing such a method or system.

The present invention relates to a method for managing the electrochemical batteries of an electrical supply installation in the event of battery failure. It also relates to a system implementing such a method and an electrical supply installation implementing such a method or such a system.

The field of the invention is the field of electrical supply installations comprising several electrochemical batteries, in particular of the LMP® type (for “Lithium Metal Polymer”), mounted in parallel, in order to provide an electrical supply signal.

### STATE OF THE ART

Stationary electrical supply installations are known, comprising several electricity storage modules mounted in parallel and each comprising one or more electrochemical batteries, in particular of the LMP® type. Each module makes it possible to store electrical energy and then deliver a high-voltage signal, for example in order to recharge an electric vehicle or in order to supply a building.

Certain stationary electrical installations are autonomous and couple energy production means, such as solar panels or wind turbines for example, with electrical energy storage modules, with a view to recharging said modules.

In order to provide sufficient autonomy in terms of supply, it is necessary to equip each installation with several batteries, allowing storage of the electrical energy necessary for the desired autonomy, in order to subsequently deliver it to an entity to be supplied, such as an electric vehicle to be recharged, or to a complex or a building to be supplied. Depending on the power required for the supply, and the power available from each battery, it may be necessary to use several batteries in parallel for the supply.

At the same time, it is known that electrochemical batteries are not suited to a slow discharge.

However, at present there is no method for managing the rechargeable electrical energy storage modules of a stationary electrical supply installation, in which these modules are placed in parallel, making it possible to optimize the life span of said modules, while retaining the functionality of the installation.

An aim of the present invention is to overcome this drawback.

Another aim of the invention is to propose a method and a system allowing better management of the electrical energy storage modules of an electrical supply installation, mounted in parallel, in the event of failure of at least one of the modules.

It is also an aim of the invention to propose a method and a system for managing the electrical energy storage modules of an electrical supply installation, mounted in parallel, allowing the life span of said modules to be optimized, while still maintaining normal operation of said installation in the event of failure of at least one of said modules.

### DISCLOSURE OF THE INVENTION

The invention makes it possible to achieve at least one of these aims by a method for managing a plurality of rechargeable electrical energy storage modules of an electrical supply installation, in particular a stationary electrical supply installation, said modules each comprising at least one rechargeable electrochemical battery, in particular of the LMP® type, and being arranged in parallel with one another, said method comprising:
separating said modules into at least two groups, and
supplying from one of said groups at once, and in particular in turn, and even more particularly alternately;
   said method also comprising a step of replacing a failing module of a group, called active group, in the process of supply, by an available module of another group, called available group.

Thus, the method according to the invention proposes to separate, virtually, the rechargeable electrical energy storage modules into several, in particular two, groups used in turn for supplying, in particular for recharging, an electric vehicle, supplying a building, supplying a complex, supplying an electrical/electronic device, in particular a communication device such as a WiFi hotspot or an antenna. Thus, it is possible to apply rapid discharge cycles to each group and thus to optimize the life span of each module.

At the same time, in the event of failure of one or more modules, the method according to the invention proposes a “virtual” management of at least one of the groups. In particular, when a module initially forming part of a first group is failing, the method proposes to replace it, in particular on the fly, by a module initially forming part of another group. Thus, it is possible to continue to deliver the power demanded and thus to operate the installation normally, even in the event of failure of one or more modules, without degrading the electrical energy storage modules.

In the present application, by “separation” is meant a virtual grouping of the modules, independently of their physical arrangement.

In the present application, it is considered that a storage module is failing when said module presents:
a malfunction, in particular an abnormal temperature or an abnormal voltage at its terminals; or
a remaining charge level (RCL) that is zero or very low.
   The remaining charge level can be identical with a gauge level indicating a percentage or an amount of charge remaining in the storage module.

According to a version of the method according to the invention, the replacement step can be carried out as soon as one of the groups includes a failing module.

In other words, in this first version, when a first module is failing in any one of the groups, the replacement step is carried out, even if no module is failing in the other groups. The failing module of the group is then replaced by an available module of another group.

The module replacing the failing module of the active group can be chosen from each of the other groups in turn.

In addition, within an available group itself, the module used to replace the failing module of an active group can be chosen from the modules of said available group in turn.

According to another, preferred, version of the method according to the invention, the replacement step can be carried out only when each group includes a failing module, i.e. when there is no longer any group all of the modules of which are operational.

In this case, when a first active group includes a failing module, the supply can be switched to another group that does not include any failing module, this other group then becoming the active group, and so on.

The group including the failing module may no longer be used for the supply while there exist other groups all the modules of which are operational, i.e. not failing. The supply can be provided with only the group(s) all the modules of which are operational, in particular in turn, without using the group the module of which is failing.

Optionally, when the group(s) all the modules of which are operational, is(are) fully discharged, then the group the module of which is failing can be used to provide a degraded supply in a degraded operation mode.

In a preferred version of the method according to the invention, the replacement step can be carried out such that the total number of modules in the active group is kept constant, and equal to a predetermined number.

In other words, the replacement step can be carried out such that the power delivered during the supply is kept constant, and equal to a predetermined value.

Thus, the method according to the invention makes it possible to maintain the power supplied by the active group, which allows a normal operation mode to be maintained, without suffering any degradation.

According to a non-limitative embodiment, the method according to the invention can comprise switching the supply from one group to another, carried out as a function of the remaining charge levels of said groups.

More particularly, switching from one group to another can be carried out when the remaining charge level of the active group is less than or equal to the remaining charge level of at least one available group, in particular of a predetermined value.

Advantageously, the predetermined value can correspond to a percentage of a maximum charge capacity (MCC) or of a remaining charge level (RCL) of at least one of the groups.

According to a first example embodiment, the predetermined value can be constant.

For example, the predetermined value can be equal to 5% of the MCC of a group.

According to another example embodiment, the predetermined value can be variable.

More particularly, the predetermined value can be a function of the available total charge level of each group.

In particular, the predetermined value can decrease when the total charge level of each group decreases.

According to a non-limitative example embodiment, the predetermined value can be equal to:
10% of the MCC of a group when all the groups have a RCL greater than 70%;
8% of the MCC of a group when the group with the least charge has a RCL comprised between 50% and 70%;
5% of the MCC of a group when the group with the least charge has a RCL comprised between 30% and 50%; and
3% of the MCC of a group when the group with the least charge has a RCL less than 30%.

In a preferred version, each group can comprise an identical number of modules.

The number of modules can be determined as a function of a required total power during the supply step and of the power that can be delivered by each module.

In a preferred version, all the modules can be identical, and each deliver one and the same nominal power.

The method according to the invention can also comprise detection of a failure, and in particular a malfunction, of a storage module as a function of:
a temperature of said module, and/or
a voltage at the terminals of said module.

In particular, a module can be failing when it has:
a remaining charge level that is zero, or less than or equal to a predetermined value, for example 0.1% of the MCC of said module;
a temperature that is not comprised within a predetermined temperature range, such as for example 50° C. to 120° C.; and/or
a voltage at the terminals of said module that is not comprised within a predetermined voltage range, such as for example 190 V to 470 V.

The method according to the invention can also comprise, for each module, measuring at least one, in particular each, of the following parameters:
a remaining charge level (RCL) of said module, for example by a battery fuel gauge;
a temperature of said module, for example by a thermometer or a thermocouple; and/or
a voltage at the terminals of said module, for example by a voltmeter.

At least one of these parameters can be used for determining if the module is failing or not.

Alternatively or in addition, at least one of these parameters, for example the remaining charge level (RCL) can be used for determining if switching to another group must be carried out or not.

According to another aspect of the same invention, a system is proposed for managing a plurality of rechargeable electrical energy storage modules of an electrical supply installation, in particular a stationary electrical supply installation, said modules each comprising at least one rechargeable electrochemical battery, in particular of the LMP® type, and being arranged in parallel with one another, said system comprising:
for each module, a means of individual connection/disconnection, making it possible to place said module on discharge independently of the other modules, and
at least one controller for controlling, directly or indirectly, each of said means of connection/disconnection;
   said at least one controller being configured in order to implement all the steps of the method according to the invention.

According to yet another aspect of the invention, an electrical supply installation is proposed, in particular a stationary electrical supply installation, comprising a plurality of rechargeable electrical energy storage modules, said modules each comprising at least one rechargeable electrochemical battery, in particular of the LMP® type, and being arranged in parallel with one another, said modules being managed:
according to the method according to the invention; or
by a system according to the invention.

Advantageously, the installation according to the invention can comprise a means of production of electrical energy from a renewable source, such as at least one solar panel and/or at least one wind turbine.

The energy produced by such a means can be used for recharging at least one rechargeable electrical energy storage module.

Alternatively, or in addition, at least one rechargeable electrical energy storage module can be recharged from the grid.

The electrical supply installation according to the invention can be an electrical recharging station for electric vehicles.

Alternatively, the electrical supply installation according to the invention can be an electrical supply installation of a building such as a cinema, a complex such as a sports ground, or an electrical/electronic communication device such as a WiFi hotspot or an antenna, etc.

### DESCRIPTION OF THE FIGURES AND EMBODIMENTS

Other advantages and characteristics will become apparent from the detailed description of embodiments which are in no way limitative, and the attached drawings, in which:

FIG. 1 is a diagrammatic representation of a non-limitative example of an electrical supply installation according to the invention;

FIGS. 2a and 2b are diagrammatic representations of two non-limitative examples of parallel connection of the electrical energy storage modules of an electrical supply installation according to the invention, and in particular of the installation in FIG. 1;

FIG. 3 is a diagrammatic representation, in the form of a flow chart, of a first non-limitative example of the method according to the invention;

FIG. 4 is a diagrammatic representation, in the form of a flow chart, of a second non-limitative example of the method according to the invention; and

FIGS. 5a-5f are diagrammatic representations of the principle of an example of the application of the method in FIG. 3 in the case of the installation in FIG. 1.

It is well understood that the embodiments that will be described hereinafter are in no way limitative. Variants of the invention can be considered in particular, comprising only a selection of the characteristics described hereinafter, in isolation from the other characteristics described, if this selection of characteristics is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

In the figures, elements common to several figures retain the same reference.

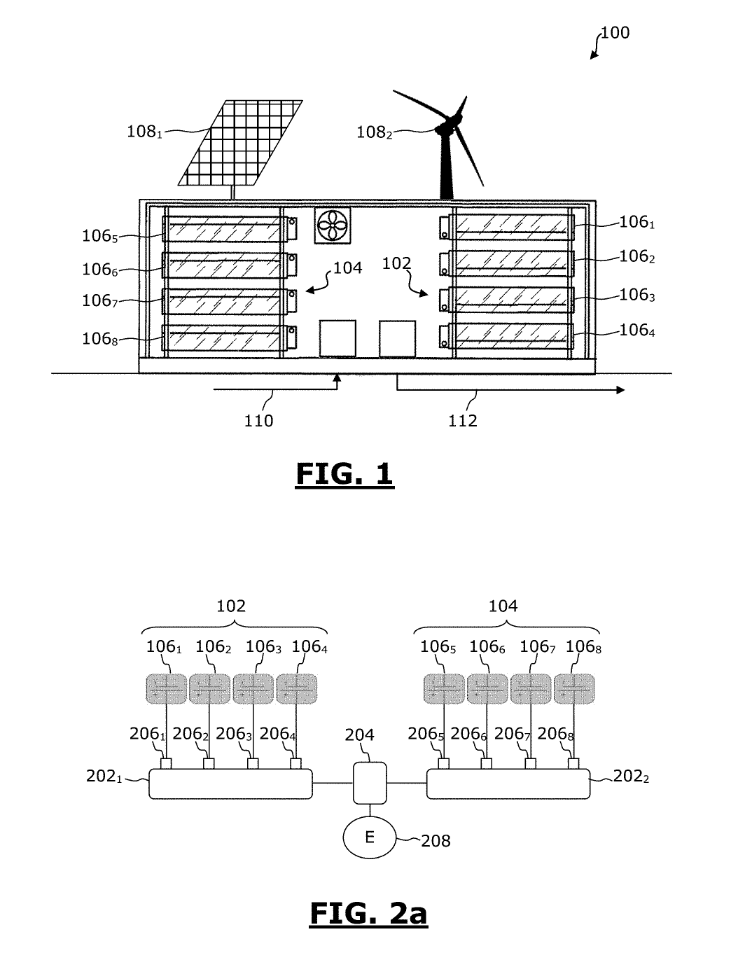

FIG. 1 is a diagrammatic representation of a non-limitative example of an electrical supply installation according to the invention.

The electrical supply installation 100, shown in FIG. 1, can be an electrical recharging station for electric vehicles such as electric buses or electric cars, a supply installation of a building, a complex, a communication device such as a WiFi hotspot or an antenna, etc.

The installation 100 comprises a first group 102 and a second group 104 each comprising four rechargeable electrical energy storage modules, namely modules 106₁-106₄ for the group 102 and modules 106₅-106₈ for the group 104.

Each rechargeable electrical energy storage module 106 comprises one or more batteries of the LMP® type (for “Lithium Metal Polymer”). The modules 106 are all identical and supply one and the same nominal power.

One or more means 108 for the production of electrical energy from a renewable source, such as for example solar panels 108₁ or one or more wind turbines 108₂, can be used for recharging the modules 106. The means of production 108 may or may not form part of the installation 100.

Alternatively or in addition, each module 106 can be recharged from an electrical energy distribution network, represented by the line referenced 110.

The installation 100 makes it possible to supply a recharging terminal, a complex, and more generally an electrical entity, via an electrical network represented by the line referenced 112. One or more controller make it possible to control the operation of the installation 100.

FIG. 2a is a diagrammatic representation of a non-limitative example of parallel connection of electrical energy storage modules in an installation according to the invention, in particular in the installation 100 in FIG. 1.

In the example shown in FIG. 2a, the modules 106₁-106₄ of the group 102 are connected to a management module 202₁, also called group controller, and the modules 106₅-106₈ of the group 104 are connected to a management module 202₂, also called group controller.

The controllers of group 202₁ and 202₂ are in turn connected to a central controller 204, which itself is connected, directly or indirectly, to an entity 208 to be supplied, marked “E”, such an entity being able to be an electric vehicle, or a building, etc.

In particular, each module 106₁-106₄ of the group 102 is connected to the group controller 202₁ via a contactor, 206₁-206₄ respectively, that can be controlled by the group controller 202₁ or by the central controller 204. Similarly, each module 106₅-106₈ of the group 104 is connected to the group controller 202₂ via a contactor, 206₅-206₈ respectively, that can be controlled by the group controller 202₂ or by the central controller 204.

Each contactor 206ᵢ can be controlled individually by the central controller 204, directly or via group controllers 202₁-202₂, in order to be placed either in a closed state allowing the current supplied by the module 106ᵢ to pass, or in an open state preventing the passage of the current supplied by the module 106ᵢ.

The central controller 204 comprises:
a means (not shown) for measuring individually a current, or remaining, charge level of each module 106,
a means (not shown) for measuring individually a temperature of each module 106, and/or
a means (not shown) for measuring individually a voltage at the terminals of each module 106.

The central controller 204 is also configured to compare each of the measured values for each module to one or more predetermined values, in order to determine if said module is failing or operational.

Of course, measuring and comparing these parameters can alternatively be carried out by a unit other than the central controller, such as for example by each group controller 202₁-202₂.

FIG. 2b is a diagrammatic representation of another non-limitative example of parallel connection of energy storage modules of an electrical supply installation according to the invention, and in particular of the installation 100 in FIG. 1.

The example shown in FIG. 2b comprises all the elements of the example in FIG. 2a, apart from the group controllers 202₁ and 202₂.

In the example shown in FIG. 2b, the modules 106₁-106₈ are directly connected to the central controllers 204 by the contactors 206₁-206₈, without using the group controllers 202₁ and 202₂. The modules 106ᵢ are then all arranged in parallel.

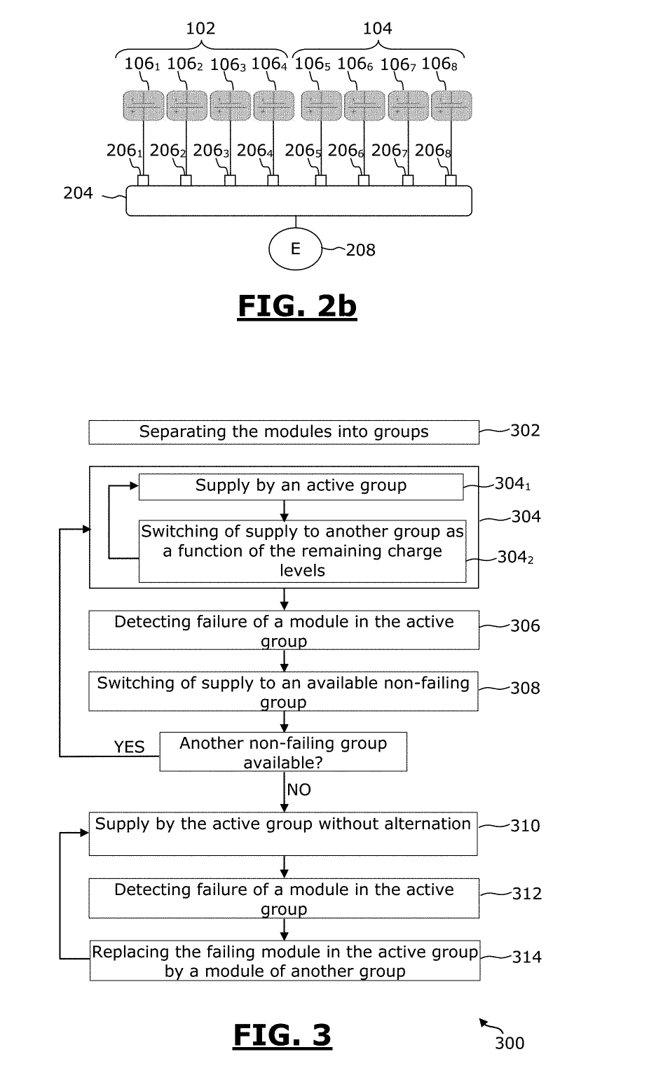

FIG. 3 is a diagrammatic representation of a first non-limitative example of a management method according to the invention.

The method 300, shown in FIG. 3, comprises a step 302 of separating the modules into several groups, for example into exactly two groups, such as the groups 102 and 104.

During this separation step 302, the physical arrangement of the modules can be taken into account for constituting the groups, for example as shown in FIG. 2a. Alternatively, it is possible not to take into account a physical arrangement of the modules, for example as shown in FIG. 2b.

During a step 304, the method 300 carries out an alternate supply from each of the groups in turn. To this end, a step 304₁ carries out a supply from one of the groups. The group in the process of supply is called active group and the other group(s) is(are) called available group(s). The remaining charge level (RCL) of the active group is monitored during the supply step 304₁. Then, as a function of a predetermined rule, a step 304₂ carries out switching of the supply to another available group, and so on.

Switching from one group to another, during step 304₂, can be carried out as a function of the remaining charge levels (RCL) of each group and the maximum charge capacity (MCC) of the groups.

In particular, switching from the active group to an available group can be carried out when the RCL of the active group becomes less than or equal to the RCL of an available group by a predetermined value, which is equal to:
10% of the MCC of a group when all the groups have a RCL greater than 70% of the MCC;
8% of the MCC of a group when the group with the least charge has a RCL comprised between 50% and 70% of the MCC;
5% of the MCC when the group with the least charge has a RCL comprised between 30% and 50% of the MCC; and 3% of the MCC when the group with the least charge has a RCL less than 30% of the MCC.

Such switching makes it possible to optimize the discharge of the set of modules and to have a substantially equivalent remaining charge level for each module.

During a step 306, a failure is detected in a charge module of the active group, for at least one of the following reasons:
the module has an insufficient RCL,
the module has an abnormal voltage at its terminals, and/or
the temperature of the module is abnormal.

Following the detection of a failing module, a step 308 carries out switching of the supply to an available group which becomes the new active group.

If after the step 308, there is still at least one other available group all the modules of which are operational, in addition to the new active group, then in step 304 the method 300 resumes alternate supply without taking the failing group into account.

If after the step 308, there is no other available group all the modules of which are operational, in addition to the new active group, then the method continues with a step 310 that carries out the supply from said active group only. There is no further switching of supply.

After the step 310, a failure is detected in a module of the active group, during a step 312, for at least one of the following reasons:
the module has an insufficient RCL,
the module has an abnormal voltage at its terminals, and/or
the temperature of the module is abnormal.

Following the detection of a failing module in the active group, and as there is no longer any other group all the modules of which are not failing, the method 300 comprises a step 314 of replacing the failing module in the active group by a module that is not failing, from another group. The active group is then reconstituted virtually with a module of another group.

The method 300 then resumes at step 310 with the reconstituted active group.

In the method 300 in FIG. 3, the replacement of a failing module of a group is then carried out only when each group comprises a failing module. Of course, the invention is not limited to this version of the method.

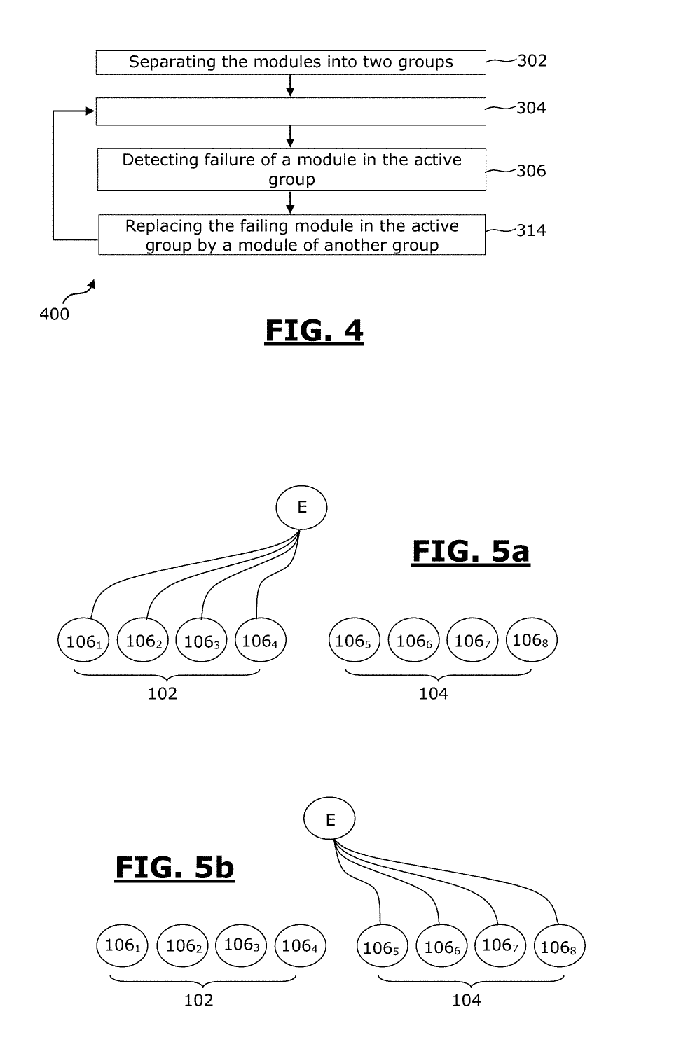

FIG. 4 is a diagrammatic representation of a second non-limitative example of a management method according to the invention.

The method 400, shown in FIG. 4, comprises the steps 302-306 of the method 300 in FIG. 3.

However, in the method 400 in FIG. 4, the step 306 of detecting a failing module in an active module is followed by step 314 of replacing the failing module in the active group, even if there remains at least one other group all the modules of which are operational.

In other words, in the method 400 in FIG. 4, replacing a failing module of an active group is carried out as soon as a first failing module is detected.

In the method 400, during the replacement step 314, the operational module used to replace the failing module of an active group can be chosen alternately from the other available groups in turn.

Alternatively or in addition, in the method 400, during the replacement step 314, the operational module for replacing the failing module of an active group can be chosen alternately from the operational modules of another group in turn.

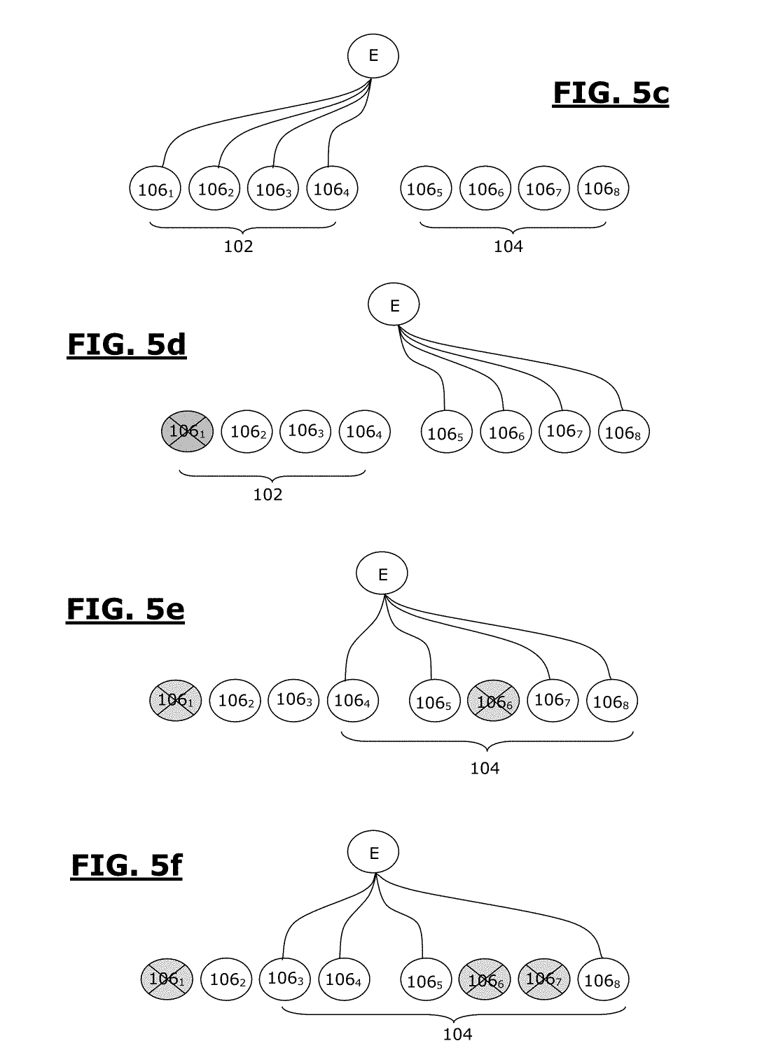

FIGS. 5a-5f are diagrammatic representations of the principle of an example of the application of the method 300 in FIG. 3 in the case of the installation in FIG. 1.

FIGS. 5a-5c show an alternate supply of an entity “E” from groups 102 and 104. Thus:
in FIG. 5a: the group 102 is the active group used for supplying the entity “E” and the group 104 is the available group;
in FIG. 5b: the supply of the entity “E” is switched to the group 104, which becomes the active group, and the group 102 becomes the available group; and
in FIG. 5c: the supply of the entity “E” is switched again to the group 102, which again becomes the active group, and the group 104 becomes the available group;
and so on.

FIG. 5d shows the case in which the module 106₁ of the group 102 is failing. The supply is switched to the group 104, without replacing the failing module 106₁. As there is no other group that is fully operational, the supply is then provided continuously by the group 104.

FIG. 5e shows the case in which a module, namely the module 106₆ of the group 104, is failing. As there is no other group that is fully operational, the failing module 106₆ is replaced by any one of the operational modules 106₂-106₄ of the group 102, namely the module 106₄ in FIG. 5e. The group 104 is then reconstituted virtually and comprises the modules 106₄, 106₅, 106₇ and 106₈.

FIG. 5f shows the case in which another module, namely the module 106₇ of the (virtually reconstituted) group 104 is failing. As there is no other group that is fully operational, the failing module 106₇ is replaced by any one of the operational modules 106₂ or 106₃ of the group 102, namely the module 106₃ in FIG. 5f. The group 104 is then reconstituted and comprises the modules 106₃, 106₄, 106₅ and 106₈.

Of course, the invention is not limited to the examples detailed above. In particular, the number of storage modules, the number of groups of modules, and the number of modules for each group are not limited to those given in the examples described above, and correspond to the maximum number of energy storage modules depending in particular on the desired autonomy and power at the level of the installation.

The invention is intended for any stationary application requiring such an installation.

1. A method for managing a plurality of rechargeable electrical energy storage modules, said modules each comprising at least one rechargeable electrochemical battery, and being arranged in parallel with one another, said method comprising:
separating said modules into at least two groups,
supplying from one of said groups at a time; and
said method also comprising a step of replacing a failing module of a group, called active group, in the process of supply, by an available module of another group, called available group.

2. The method according to claim 1, characterized in that the replacement step is carried out as soon as one of the groups includes a failing module.

3. The method according to claim 1, characterized in that the replacement step is carried out only when each group includes a failing module.

4. The method according to claim 1, characterized in that the replacement step is carried out so as to maintain a constant number of modules in the active group.

5. The method according to claim 1, characterized in that it comprises switching the supply from one group to another carried out when the remaining charge level of the active group is less than or equal to the remaining charge level of at least one available group, of a predetermined value.

6. The method according to claim 5, characterized in that the predetermined value corresponds to a percentage of a maximum charge capacity, or of a remaining charge level, of at least one of the groups.

7. The method according to claim 5, characterized in that the predetermined value is variable as a function of the available total charge level of each group.

8. The method according to claim 1, characterized in that each group comprises an identical number of modules.

9. The method according to claim 1, characterized in that it comprises detecting failure of a storage module as a function of:
a remaining charge level of said module;
a temperature of said module; and/or
a voltage at the terminals of said module.

10. The method according to claim 1, characterized in that it comprises measuring, for each module, at least one of the following parameters:
a remaining charge level of said module;
a temperature of said module; and/or
a voltage at its terminals.

11. A system for managing a plurality of rechargeable electrical energy storage modules of an electrical supply installation, said modules each comprising at least one rechargeable electrochemical battery, and being arranged in parallel with one another, said system comprising:
for each module, a means for individual connection/disconnection, making it possible to place said module on discharge independently of the other modules; and
at least one controller for controlling, directly or indirectly, each of said connection/disconnection means;
said at least one controller being configured in order to implement all the steps of the method according to claim 1.

12. An electrical supply installation comprising a plurality of rechargeable electrical energy storage modules, said modules each comprising at least one rechargeable electrochemical battery, and being arranged in parallel with one another, said modules being managed:
according to a method for managing a plurality of rechargeable electrical energy storage modules of an electrical supply installation, said modules each comprising at least one rechargeable electrochemical battery, and being arranged in parallel with one another, said method comprising:
separating said modules into at least two groups;
supplying from one of said groups at a time; and
said method also comprising a step of replacing a failing module of a group, called active group, in the process of supply, by an available module of another group, called available group; or
by a system according to claim 11.

13. The installation according to claim 12, characterized in that it comprises a means for the production of electrical energy from a renewable source, such as at least one solar panel and/or at least one wind turbine.

14. The installation according to claim 12, characterized in that this is:
an electrical recharging station for electric vehicles, or
an electrical supply installation of a building, a complex or an electrical/electronic communication device.
